(19) United States
(12) Patent Application Publication
(10) Pub. No.: US 2008/0106677 A1
(43) Pub. Date: May 8, 2008

(54) ELECTRODE STRUCTURE CAPABLE OF REFLECTING COLOR LIGHT AND LCOS PANEL

(75) Inventors: Da-Shuang Kuan, Hsinchu County (TW); Chun-Sheng Fan, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: United Microdisplay Optronics Corp., Hsinchu City (TW)

(21) Appl. No.: 11/556,200

(22) Filed: Nov. 3, 2006

(51) Int. Cl. G02F 1/1335

(52) U.S. Cl. 349/108; 349/106

(57) ABSTRACT

An electrode structure including a substrate, an electrode structural layer and a color reflection layer is provided. The substrate includes a circuit already formed thereon. The electrode structural layer is disposed over the substrate and electrically coupled to the circuit. The color reflection layer is disposed over the electrode structural layer. When light is incident on the color reflection layer and the electrode structural layer, the color reflection layer only reflects light of a specific color range. Furthermore, according to the electrode structure, a reflective LCOS panel and a projection-type displaying apparatus can be manufactured.

### BACKGROUND OF THE INVENTION

1. Field of the Invention

The present invention relates to a liquid crystal display technique, and more particularly, to an electrode structure used in a liquid crystal display capable of reflecting light in a specific color range and applying to a reflective liquid crystal on silicon (LCOS) panel and a projection-type displaying apparatus.

2. Description of Related Art

One of the principal characteristics of a reflective liquid crystal on silicon (LCOS) panel is that most of the driving devices are formed on a lower substrate and the liquid crystal layer is formed between the lower substrate and an upper substrate. Light rays from a light source enter from the upper substrate, travel to the lower substrate and are reflected through the reflective layer on the lower substrate. Hence, the driving devices will not block the reflected light rays and the utilization rate of the light rays is increased.

The reflective LCOS panel can be used to form a projective-type displaying apparatus. FIG. 1 is a schematic diagram showing the structure of a conventional projective-type displaying apparatus. As shown in FIG. 1, a white beam 100 is incident on a dichroic mirror 102. The dichroic mirror 102 splits up the white beam 100 into a blue beam 106 and a red-and-green mixed beam 104 according to the color range of light. A reflecting mirror 108 along the transmission path reflects the red-and-green mixed beam 104 into a required path direction. Then, the red-and-green mixed beam is again split up into a red beam 112 and a green beam 114 through a dichroic mirror 110. The green beam 114 is, for example, incident on a polarized beam splitter (PBS) 116. The polarized beam splitter 116 reflects S-polarized light but allows the P-polarized light to pass through, for example. Therefore, a portion of the S-polarized light beam of the green beam 114 is deflected 90° into a LCOS panel 118. The driving device of each pixel inside the LCOS panel 118 drives and controls the degree of rotation of the liquid crystal inside each pixel. Thus, after the incident S-polarized green light has been reflected from the LCOS panel 118, a P-polarized portion is generated according to the degree of rotation driven by each pixel. Hence, the P-polarized portion of the reflected green light may penetrate an identical polarized beam splitter 116 and obtain a green image 120, wherein the gray scale is determined by the degree of the P-polarization as a result of the degree of rotation of the liquid crystal.

According to a similar mechanism, the red beam 112 generates a red image 126 through a polarized beam splitter 122 and a LCOS panel 124. Again, through a similar mechanism, the blue beam 106 generates a blue image 134 through a polarized beam splitter 130 and a LCOS panel 132. Then, through a light integration mirror 136, the green image 120, the red image 126 and the blue image 134 are combined to form a color image 138. Afterward, through a projection unit 140, the color image 138 is magnified into another image 142 and projected on a screen (not shown in the figure).

In the foregoing conventional projection-type displaying apparatus, a number of dichroic mirrors 102, 110 is required to split up the red beam, the green beam and the blue beam. Furthermore, if a common beam splitter instead of a dichroic mirror is used so that three white beams are produced, then an additional filter plate has to be disposed along the optical path to obtain the required red, green and blue color lights, or according to a frequency point of view, the required red, green and blue color ranges.

The conventional projection-type displaying apparatus requires either dichroic mirrors or filter plates so that at least the production cost of the apparatus is higher and the volume of the apparatus is larger. Although most filter plates can be fabricated on the LCOS panel, the filter plates are individually added elements. In other words, the conventional LCOS panel has no provision for distinguishing the difference between color lights unless there is a filter plate.

### SUMMARY OF THE INVENTION

Accordingly, the present invention provides an electrode structure belonging to a part of a driving circuit and capable of reflecting the required color ranges.

The present invention also provides an electrode structure such that three units constitute a pixel and each unit is capable of independently reflecting a specified color range, for example, directly reflecting red light, green light or blue light from white light.

The present invention also provides an electrode structure such that three units constitute a pixel and the units reflects red light, green light or blue light respectively to achieve an image displaying effect.

The present invention also provides a reflective liquid crystal on silicon (LCOS) panel that utilizes a three-in-one pixel design to achieve a single panel displaying effect.

The present invention also provides a projection-type displaying apparatus that uses single reflective LCOS panels to display image so as to reduce the cost of production, volume and complexity of a displaying apparatus.

As embodied and broadly described herein, the present invention is directed to an electrode structure comprising a substrate, an electrode structure layer and a color reflection layer. The substrate includes a circuit already formed thereon. The electrode structural layer is disposed over the substrate and electrically coupled to the circuit. The color reflection layer is disposed over the electrode structural layer. When light is incident on the color reflection layer and the electrode structural layer, the color reflection layer only reflects light of a specific color range.

The present invention is also directed to an electrode structure comprising a substrate, a plurality of electrode structure layers and a plurality of color reflection layers. The substrate includes a circuit already formed thereon. The electrode structural layers are formed on the substrate and electrically coupled to the circuit. The color reflection layers are respectively formed on the electrode structural layers. When light is incident on the color reflection layers and the electrode structural layers, each color reflection layer only reflects light of a specific color range.

The present invention is further directed to a reflective LCOS panel comprising a first substrate, a plurality of electrode structural layers, a plurality of color reflection layers, an alignment layer, a second substrate and a liquid crystal layer. The first substrate includes a first circuit already formed thereon. The electrode structural layers are formed on the first substrate and electrically coupled to the circuit. The color reflection layers are respectively formed on the electrode structural layers, wherein the foregoing color reflection layers are grouped in threes to form a pixel corresponding to red, green and blue. When light is incident on the color reflection layers and the electrode structural layers, each color reflection layer only reflects one of red light, green light and blue light. The alignment layer covers over the color reflection layers. The second substrate includes a second circuit already formed thereon. The liquid crystal layer is disposed between the first substrate and the second substrate.

The present invention is also directed to a projection-type displaying apparatus including a white light source, a reflective LCOS panel and a polarized beam splitter. The white light source provides a light beam. The reflective LCOS panel includes a plurality of pixels, and each one of the pixels is able to reflect a specific color range after the light beam has been received through a color reflection layer. The polarized beam splitter is disposed to correspond with the reflective LCOS panel. Through the polarized beam splitter, a polarized light beam having a polarizing direction in the light beam is incident on the reflective LCOS panel. The reflective LCOS panel corresponding to the pixels reflects their respective color ranges. Furthermore, through the control of the liquid crystal layer, the polarizing direction of the polarized light beam is changed. Afterwards, the beam enters the polarized beam splitter to project an image.

According to the foregoing electrode structure in another preferred embodiment of the present invention, the color reflection layers are surface layers on the electrode structural layers. Each surface layer includes a photon crystal structure comprising a plurality of recess areas for reflecting the corresponding lighted area.

According to the foregoing electrode structure in another preferred embodiment of the present invention, the color reflection layers are nano-structure layers fabricated from an inorganic material for reflecting the corresponding lighted areas. According to another preferred embodiment, each nano-structure layer includes, for example, a nano-particle layer, or a quantum dot layer, or a photon crystal layer.

According to one embodiment of the present invention, because the color reflection layers are directly formed on the pixel electrodes, the pixel electrodes can directly reflect red light, green light and blue light respectively. Therefore, the present invention is able to reduce the required number of filter plates or dichroic mirrors.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing the structure of a conventional projective-type displaying apparatus.

FIG. 2 is a diagram showing the optical interference phenomenon used as theoretical base for the operation of the present invention.

FIG. 3 is a diagram showing electrode structures capable of reflecting specific color ranges according to an embodiment of the present invention.

FIG. 4 is a diagram showing electrode structures capable of reflecting specific color ranges according to another embodiment of the present invention.

FIG. 5 is a diagram showing electrode structures capable of reflecting a specific color ranges according to another embodiment of the present invention.

FIG. 6 is a schematic cross-sectional view of a reflective LCOS panel according to one embodiment of the present invention.

FIG. 7 is a schematic cross-sectional view of a projective-type displaying apparatus according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

To provide further improvements to the conventional reflective liquid crystal on silicon (LCOS) panel, the present invention researches on chromatic phenomenon of optics and concludes that optical interference phenomenon is related to color light. FIG. 2 is a diagram showing the optical interference phenomenon used as theoretical base for the operation of the present invention. As shown in FIG. 2, a plurality of regularly spaced trenches is formed on a reflective surface 200. When light of a frequency range, for example, white light 202 is incident on the reflective surface 200, a portion of the light 204 is reflected from the bottom of the trenches while another portion of the light 206 is reflected from the normal surface of the reflective surface 200. Due to the trenches, there is a certain degree of phase difference between the reflected light 204 and the reflected light 206. If the width and the depth of the trenches are set up properly aiming for reflected light 204 and 206 of a specific wavelength, destructive interference phenomenon may occur due to their phase difference. Consequently, a color light different from the white light is obtained after the interference between the reflected lights 204 and 206.

After the observation of the foregoing optical phenomenon, a further investigation has shown that this type of optical phenomenon is also found in the R & D of material physics. Moreover, this optical phenomenon also happens on objects used in our daily life, for example, the coloring of protein rocks. Furthermore, the coloration on the surface of some insects or fish scales can be explained in part by special optical interference.

From the point of view of physics, these interference phenomena happen as a result of photon crystal structure, or the organic material of the nano-particles or quantum dots. According to the size and arrangement of the particles, light corresponding to a specific color range is reflected.

According to the result of research in the present invention, an electrode structure having a color reflection layer formed on the electrode is proposed. In tandem with the electrical operation of the electrode, a specific color is also reflected. The color reflection layer is used for reflecting out a required color range so that any material that meets this demand is suitable. However, inorganic material is preferred because inorganic material is able to withstand a higher temperature and permits the incident of high-intensity light for a longer period. In particular, when the electrode is used as a pixel electrode on a display, it is illuminated by a light source for a long period of time. In order to increase the brightness of the display, a high-intensity light source is often used. Therefore, inorganic material is more appropriate. However, this is not an essential limitation of the present invention. In the following, a few embodiments are used to explain the present invention. However, the present invention is not limited by the embodiments.

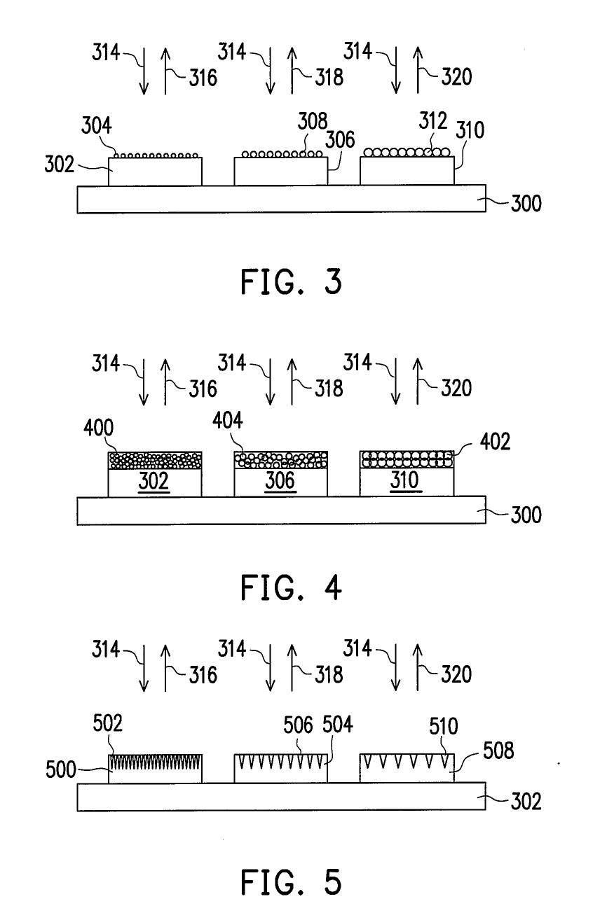

FIG. 3 is a diagram showing electrode structures capable of reflecting specific color ranges according to an embodiment of the present invention. As shown in FIG. 3, a plurality of electrode structural layers 302, 306 and 310 is formed on a substrate 300. Here, the number of electrode structural layers depends on the actual requirement. In the present embodiment, three electrode structural layers are used. Understandably, a few driving circuits electrically connected to the electrode structural layers 302, 306, 310 are also disposed on the substrate 300. A detailed description of these circuits is omitted.

The electrode structural layer 302 is used for reflecting red light. A color reflection layer 304, for example, a gold nano-particle layer or a gold quantum dot layer capable of reflecting out light in the red range, is formed on the electrode structural layer 302. The material constituting the gold nano-particle layer includes gold nano-particles, for example. In general, this reflective phenomenon is a quantum effect. When the particle diameters are equal to or greater than the wavelength of the incident light rays, the particles will absorb and reflect the incident light. However, when the particle diameters are much smaller than the wavelength of the incident light, the particles will mainly absorb the incident light.

Gold nano-particles generate a peak resonance with light at a wavelength of about 500 nm. After the light energy has been absorbed, the free electron cloud of the gold nano-particles is polarized and vibrates according to the frequency of the light wave. In the meantime, the green light and the blue light are absorbed by the gold nano-particles. By controlling the size and shape of the gold nano-particles, its reaction to red light can be enhanced to so that the red light is effectively reflected. Hence, the electrode structural layer 302 and the color reflection layer 304 for red light can serve as a red pixel electrode.

A similar physical phenomenon occurs for other types of nano-particles, for example, green light is generated by silver nano-particles and blue light is generated by gallium nano-particles. In other words, the color reflection layer 308 for green light is, for example, a silver nano-particle layer or a silver quantum dot layer formed on the electrode structural layer 306 to constitute a green pixel electrode. Similarly, the color reflection layer 312 for blue light is, for example, a gallium nano-particle layer or a gallium quantum dot layer formed on the electrode structural layer 310 to constitute a blue pixel electrode. The nano-particles may be directly formed on the electrode so that the nano-particles can directly replace a color filter plate. In addition, there is no need to use a dichroic mirror to split the color range. For example, corresponding to the same incident white light 314, the color ranges 316, 318, 320 corresponding to the red, green and blue color ranges are reflected. When the foregoing pixel electrode structures are applied to the liquid crystal image display technique, the optical devices on the optical path are simplified and overall volume of the display is reduced. The applications of the pixel electrode structures are described in the following.

As mentioned before, the formation of nano-particles is not the only method for fabricating the color reflection layer. In the following, the same effect can be achieved through an embodiment involving photon crystals. In general, most observable reactions of the photon crystals with regard to the color ranges include, for example, a multi-layered optical film. Because the cyclically arranged multi-layered dielectric film may lead to a one-dimensional photon gap, photons within a certain waveband can hardly penetrate so as to attain higher reflection efficiency. Those having cyclically arranged two- or three-dimensional structure are the so-called photon crystals, which can have a number of applications. In the present invention, the photon crystals are used together with the electrode structural layer to produce a pixel electrode structure capable of reflecting color in a specified color range and hence find applications in displaying images.

FIG. 4 is a diagram showing electrode structures capable of reflecting specific color ranges according to another embodiment of the present invention. As shown in FIG. 4, color reflection layers 400, 404 and 402 fabricated using photon crystals and corresponding to different color ranges may also be formed on the electrode structural layers 302, 306 and 310 respectively. The photon crystals are formed, for example, by stacking lots of silicon oxide (SiO₂) particles. By controlling the size of the SiO₂ particles, each color reflection layer is able to reflect, for example, only the light in red, green or blue color range. A printing method, for example, may be used to coat the SiO₂ particles on the electrode structural layer. Consequently, the color reflection layers 400, 404, 402 also produce the same effects as the color reflection layer 304, 308 and 312.

The color reflection layers in the foregoing embodiment are films on the electrode structural layers. However, according to the characteristics of the photon crystals, the color reflection layers may be directly formed on surface layers of the electrode structures. FIG. 5 is a diagram showing electrode structures capable of reflecting specific color ranges according to another embodiment of the present invention. As shown in FIG. 5, color reflection layers 502, 506, 510 comprising photon crystals are directly formed on the surface layers of the electrode structural layers 500, 504 and 508 respectively. For example, regularly arranged recess pits are formed on the surface layers of the electrode structural layers 500, 504 and 508 to produce the characteristics of the photon crystals. The shape of the recess pits may be designed and varied according to the actual color range desired. Since the crystal density of the recess pits is the main factor determining the color range, different color ranges will correspond to different photon crystals. In addition, other material different from the material of the electrode structures may also fill the recess pits to approach the photon crystal structures.

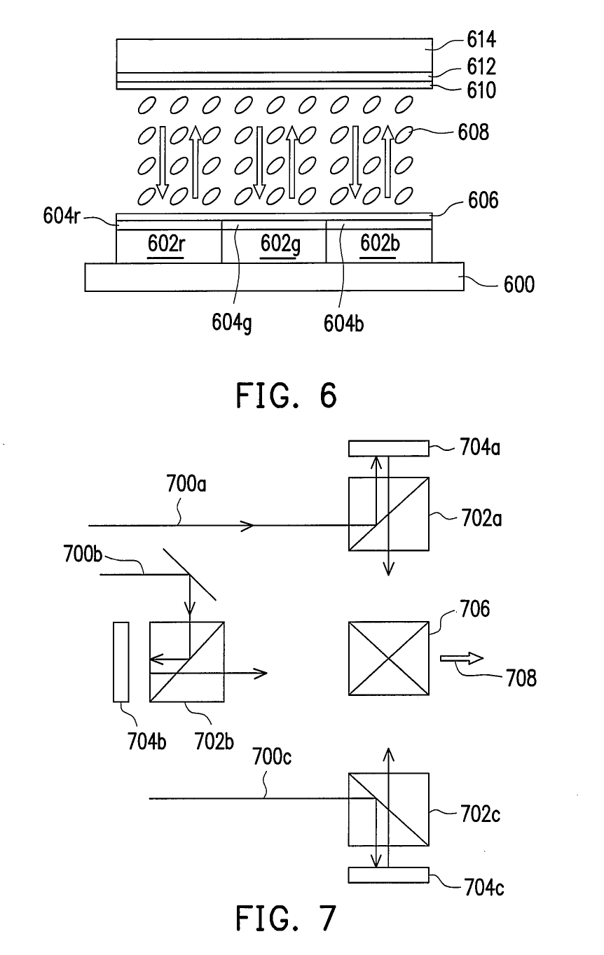

Next, according to foregoing pixel electrodes with different color ranges, three electrodes including a red, a green and a blue electrode can be grouped together to form a pixel. The pixel can be applied to a reflective LCOS panel. FIG. 6 is a schematic cross-sectional view of a reflective LCOS panel according to one embodiment of the present invention. As shown in FIG. 6, the reflective LCOS panel includes, for example, a lower substrate 600, a plurality of electrode structural layers 602r, 602g, 602b, a plurality of color reflection layers 604r, 604g, 604b, an alignment layer 606, an upper substrate 614 and a liquid crystal layer 608.

The lower substrate 600 includes a circuit, for example, a driving circuit, already formed thereon and the circuit is electrically coupled to the electrode structural layers 602r, 602g and 602b. Here, only the three electrode structural layers 602r, 602g, 602b of a pixel corresponding to the red, green and blue sub-pixels are shown. The color reflection layers 604r, 604g, 604b are formed on the electrode structural layers 602r, 602g and 602b respectively. Three of the color reflection layers 604r, 604g, 604b that correspond to red, green and blue constitute a pixel. When white light is incident on these color reflection layers and the electrode structural layers, the color reflection layers 604r, 604g, 604b only reflect one of red light, green light and blue light respectively.

In general, an alignment layer 606 is disposed on the surface in contact with the liquid crystal layer 608 to control the rotation of liquid crystal so that the liquid crystal molecules can have a better initial direction of arrangement. If the planarity of the alignment layer 606 is increased, the result of the alignment will even be better. The alignment layer 606 in the embodiment of the present covers the color reflection layers 604r, 604g and 604b. Since the color reflection layers in the present invention are allowed a certain degree of planarity, the planarity of the alignment layer 606 is ensured.

The upper substrate 614 is disposed above the lower substrate 600 and the liquid crystal layer 608 is disposed between the upper substrate 614 and the lower substrate 600. In general, anyone familiar with the technology should understand that the lower substrate 600 and the upper substrate 614 might further include other structures and circuits. For example, the upper substrate 614 may further comprise a transparent electrode layer 612, for example, an indium-tin-oxide (ITO) layer, serving as another electrode. Furthermore, the interface with the upper substrate 614 and the liquid crystal layer 608 may further include another alignment layer 610, for example.

Inside the reflective LCOS panel according to the embodiment of the present invention, color reflection layers with different color ranges are formed on the electrode structural layers of the pixel electrode structure. Therefore, when white light is incident on the sub-pixels each having a different color range, color lights such as red, green and blue light are reflected out.

The foregoing reflective LCOS panel is designed according to a single panel mechanism. Therefore, each pixel comprises sub-pixels of three colors. If a three-panel mechanism is deployed, three reflective LCOS panels in three color ranges can be relied on to process images belonging to different color ranges before the images are combined to form an actual image.

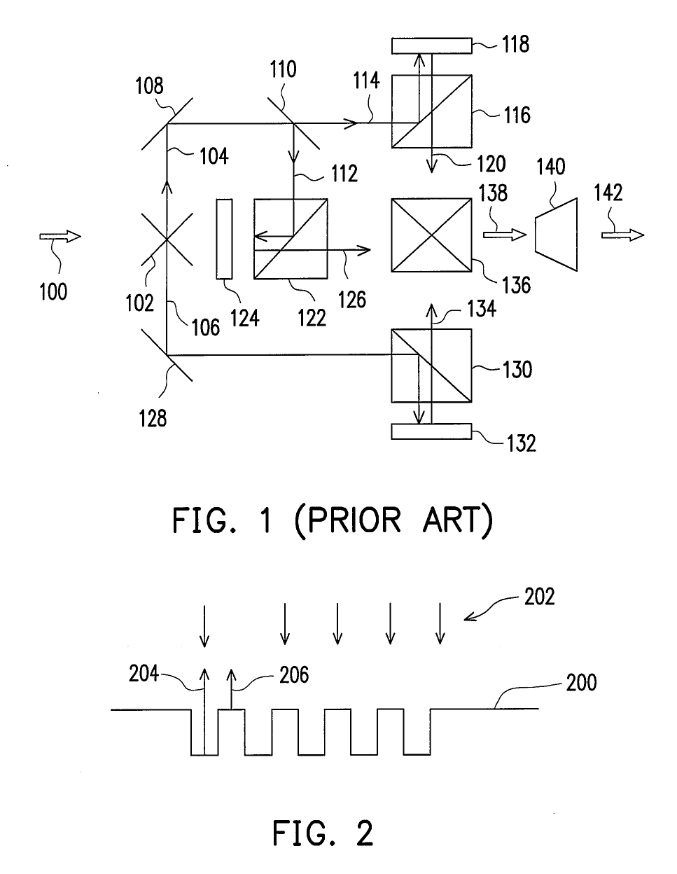

In the following, a projective-type displaying apparatus having three reflective LCOS panels is used as an example for the description. FIG. 7 is a schematic cross-sectional view of a projective-type displaying apparatus according to one embodiment of the present invention. As shown in FIG. 7, three white beams 700a, 700b and 700c enter the polarized beam splitters 702a, 702b and 702c respectively. The beams are reflected respectively by the reflective LCOS panels 704a, 704b and 704c that correspond to the red, green and blue color ranges into the light integration mirror 706. The light integration mirror 706 combines all three colored images to form an actual image 708. Since the mechanism is similar to the one in FIG. 1, a detailed description is omitted. However, it should be noticed that the reflective LCOS panels in the present embodiment utilizes the mechanism of the color reflection layers to control of the color ranges of red, green and blue light.

On the other hand, if a single reflective LCOS panel design is deployed, the configuration shown in FIG. 6 can be used. Hence, only a single optical path is required. Because of the single panel design, the light integration mirror 708 shown in FIG. 7 can be eliminated. For example, only the white beam 700a is required and the reflective LCOS panel shown in FIG. 6 replaces the reflective LCOS panel 704a.

In other words, the projection-type displaying apparatus in the present invention may include a white light source, a reflective LCOS panel and a polarized beam splitter. The white light source provides a light beam. The reflective LCOS panel includes a plurality of pixels, and each pixel is able to reflect a specific color range after the light beam has been received through a color reflection layer. The polarized beam splitter is disposed to correspond with the reflective LCOS panel. Through the polarized beam splitter, a polarized light beam having a polarizing direction in the light beam is incident on the reflective LCOS panel. The reflective LCOS panel corresponding to the pixels reflects their respective color ranges. Furthermore, through the control of the liquid crystal layer, the polarizing direction of the polarized light beam is changed. Afterwards, the beam enters the polarized beam splitter to project an image.

Because the color reflection layers are directly formed on the pixel electrodes in the present invention, the pixel electrodes can directly reflect red light, green light and blue light respectively. Therefore, the present invention is able to reduce the required number of filter plates or dichroic mirrors. Furthermore, because the color reflection layers are formed from inorganic material, the color reflection layers can withstand a bright light source. Additionally, because the color reflection layers are provided with a high degree of planarity, the planarity of the alignment layer is superior so that a better liquid crystal alignment effect is obtained.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electrode structure, comprising:
a substrate having a circuit already formed thereon;
an electrode structural layer, formed on the substrate and electrically coupled to the circuit; and
a color reflection layer, formed on the electrode structural layer, wherein the color reflection layer only reflects a specific color range when an incident light is incident on the color reflection layer and the electrode structural layer.

2. The electrode structure of claim 1, wherein the color reflection layer is a surface layer of the electrode structure and the surface layer has a photon crystal structure formed from a plurality of recess areas for reflecting the corresponding color range.

3. The electrode structure of claim 1, wherein the color reflection layer is an inorganic material nano-structure layer for reflecting the corresponding color range.

4. The electrode structure of claim 3, wherein the nano-structure layer comprises a nano-particle layer or a quantum dot layer.

5. The electrode structure of claim 3, wherein the nano-structure layer comprises a photon crystal layer.

6. An electrode structure, comprising:
a substrate, having a circuit already formed thereon;
a plurality of electrode structural layers, formed on the substrate and electrically coupled to the circuit; and
a plurality of color reflection layers, respectively formed on the electrode structural layers, wherein each color reflection layer only reflects one of color ranges when an incident light is incident on the color reflection layers and the electrode structural layers.

7. The electrode structure of claim 6, wherein the color reflection layers are surface layers of the electrode structural layers and each surface layer has a photon crystal structure for reflecting the corresponding color range.

8. The electrode structure of claim 6, wherein the color reflection layers are inorganic material nano-structure layers for reflecting the corresponding color ranges respectively.

9. The electrode structure of claim 8, wherein each nano-structure layer comprises a nano-particle layer or a quantum dot layer.

10. The electrode structure of claim 8, wherein each nano-structure layer comprises a photon crystal layer.

11. The electrode structure of claim 6, wherein three color reflection layers are grouped together to form a pixel for reflecting one of red light, green light and blue light respectively.

12. A reflective liquid crystal on silicon (LCOS) panel, comprising:
a first substrate, having a first circuit already formed thereon;
a plurality of electrode structural layers, formed on the first substrate and electrically coupled to the circuit;
a plurality of color reflection layers, respectively formed on the electrode structural layers, wherein three of the color reflection layers corresponding to red, green and blue are grouped together to form a pixel, and each color reflection layer only reflects one of red light, green light and blue light;
an alignment layer, covering the color reflection layers;
a second substrate, having a second circuit already formed thereon; and
a liquid crystal layer, disposed between the first substrate and the second substrate.

13. The reflective LCOS panel of claim 12, wherein the color reflection layers are surface layers of the electrodes structural layers and each surface layer has a photon crystal structure for reflecting the corresponding color range.

14. The reflective LCOS panel of claim 12, wherein the color reflection layers are inorganic material nano-structure layers for reflecting the corresponding color ranges respectively.

15. The reflective LCOS panel of claim 14, wherein each nano-structure layer comprises a nano-particle layer or a quantum dot layer.

16. The reflective LCOS panel of claim 14, wherein each nano-structure layer comprises a photon crystal layer.

17. A projective-type displaying apparatus, comprising:
a white light source, for providing at least a light beam;
at least a reflective liquid crystal on silicon (LCOS) panel, comprising a plurality of pixels, each pixel receives the light beam through a color reflection layer on a pixel electrode and reflects a specific color range; and
at least a polarized beam splitter, disposed to correspond with the reflective LCOS panel,
wherein, through the polarized beam splitter, a polarized light beam having a polarizing direction in the light beam is incident on the reflective LCOS panel, the reflective LCOS panel corresponding to the pixels reflects their respective color ranges, and through the control of the liquid crystal layer, the polarizing direction of the polarized light beam is changed, and then the beam enters the polarized beam splitter to project an image.

18. The projective-type displaying apparatus of claim 17, wherein each of the pixels of the reflective LCOS panel comprises three sub-pixels corresponding to a red color range, a green color range and a blue color range respectively.

19. The projective-type displaying apparatus of claim 17, wherein three reflective LCOS panels corresponding to red, green, and blue color ranges are used and the pixels in each reflective LCOS panel have identical color range.

20. The projective-type displaying apparatus of claim 17, wherein each color reflection layer comprises a nano-structure layer or a photon crystal layer.
